(19) United States
(12) Patent Application Publication
(10) Pub. No.: US 2024/0135213 A1
(43) Pub. Date: Apr. 25, 2024

(54) INFORMATION PROCESSING APPARATUS, INFORMATION PROCESSING METHOD AND PROGRAM

(71) Applicant: Nippon Telegraph and Telephone Corporation, Tokyo (JP)

(72) Inventors: Ryosuke SATO, Musashino-shi, Tokyo (JP); Kyoko YAMAGOE, Musashino-shi, Tokyo (JP); Toshihiko SEKI, Musashino-shi, Tokyo (JP); Atsushi TAKADA, Musashino-shi, Tokyo (JP); Mizuto NAKAMURA, Musashino-shi, Tokyo (JP)

(21) Appl. No.: 18/278,230

(22) PCT Filed: Feb. 26, 2021
(86) PCT No.: PCT/JP2021/007449

§ 371 Date: Aug. 21, 2023

(51) Int. Cl. G06N 7/01

(52) U.S. Cl. CPC G06N 7/01

(57) ABSTRACT

An information processing device that designs a Bayesian network includes: an input unit configured to input, as elements of a Bayesian network, information regarding a plurality of nodes, an edge indicating a causal relation between a master node and a slave node in the plurality of nodes, and a weight indicating the degree of influence of a definition content of the master node on a probability distribution of the slave node; and a generation unit configured to generate a Bayesian network using the input information.

### TECHNICAL FIELD

The present invention relates to an information processing device, an information processing method, and an information processing program.

### BACKGROUND ART

Artificial intelligence for IT operations (AIOps) for achieving automation and efficiency of IT businesses by causing AI to learn various types of data such as big data used in IT business is known. For example, there is an orchestrator that sequentially uses AI that identifies an event, AI that identifies a cause of occurrence of the event, AI that searches for a method of coping with the event, AI that identifies an influence of the event, and AI that determines a method of coping with the event.

In the AIOps, when the AI makes an error in determination, there is concern of service quality deteriorating due to a longer time of failure recovery, and of it being difficult to withstand an actual operation. In order to correct the error in the determination of AI, it is necessary for an advanced operator with an operation skill, a machine learning skill, and mathematical knowledge to take a complicated measure. Therefore, there is a need for a technology for establishing an AI teaching technique to infer validity of output results of various types of AI and implementing safe and secure operation by speeding up failure recovery and allowing operators to be less skilled.

Accordingly, there is a technology in which AI can be safely embedded in an NW operation by verifying the determination of the AI and explaining the reason for the determination by a Bayesian network that simulates the flexible determination of an experienced operator. In the Bayesian network software, design and operation of the Bayesian network can be performed on a GUI basis.

When a Bayesian network is designed, a node indicating a determination element and an edge (arrow line) indicating a causal relation between nodes are set, and a probability of a slave node is set in a conditional probability table (CPT). For example, in the case of a Bayesian network regarding determination of Loses, Sick, Dry, and Loses are set, and Sick and Dry are set as a connection source and Loses are set as a connection destination. An occurrence probability and a non-occurrence probability of Loses are set for a combination of an index value or a probability of Sick and an index value or a probability of Dry (see Non Patent Literature 1).

### CITATION LIST

### Non Patent Literature

Non Patent Literature 1: HUGIN EXPERT, “Building a Bayesian Network”, retrieved on Feb. 10, 2021 <URL:https://hugin.com/wp-content/uploads/2016/05/Building-a-BN-Tutorial.pdf>

### SUMMARY OF INVENTION

### Technical Problem

In the Bayesian network, a determination model in which human experience is reflected can be designed by a graphical model by nodes, edges, and CPT. However, the node and the edge can be intuitively set based on knowledge, but a probability of a slave node set in the CPT is manually calculated based on the statistical information of operational data. Therefore, there is a problem that an amount of work at the time of generation of the CPT is large, and thus a high degree of mathematical knowledge regarding conditional probabilities such as Bayesian inference and mathematical knowledge for shaping data according to a statistical method is required.

The present invention has been made in view of the above circumstances, and an objective of the present invention is to provide a technology capable of designing a Bayesian network without requiring mathematical knowledge.

### Solution to Problem

According to an aspect of the present invention, an information processing device that designs a Bayesian network includes: an input unit configured to input, as elements of a Bayesian network, information regarding a plurality of nodes, an edge indicating a causal relation between a master node and a slave node in the plurality of nodes, and a weight indicating the degree of influence of a definition content of the master node on a probability distribution of the slave node; and a generation unit configured to generate a Bayesian network using the input information.

According to another aspect of the present invention, an information processing method performed by an information processing device that designs a Bayesian network includes: a step of inputting, as elements of a Bayesian network, information regarding a plurality of nodes, an edge indicating a causal relation between a master node and a slave node in the plurality of nodes, and a weight indicating the degree of influence of a definition content of the master node on a probability distribution of the slave node; and a step of generating a Bayesian network using the input information.

According to still another aspect of the present invention, an information processing program is an information processing program that causes a computer to function as the information processing device.

### Advantageous Effects of Invention

According to the present invention, it is possible to provide a technology capable of designing a Bayesian network without requiring mathematical knowledge.

### BRIEF DESCRIPTION OF DRAWINGS

FIG. 1 is a diagram illustrating a functional block configuration of an information processing device.

FIG. 2 is a diagram illustrating a processing flow of the information processing device.

FIG. 3 is a diagram illustrating an example of a Bayesian network.

FIG. 4 is a diagram illustrating an example of a probability distribution of slave nodes.

FIG. 5 is a diagram illustrating an example of a CPT of a slave node.

FIG. 6 is a diagram illustrating a hardware configuration of an information processing device.

### DESCRIPTION OF EMBODIMENTS

Hereinafter, an embodiment of the present invention will be described with reference to the drawings. In the drawings, the same portions are denoted by the same reference signs, and description thereof is omitted.

### SUMMARY OF INVENTION

According to the present invention, in addition to a node, an edge, and a CPT, a weight indicating the degree of influence of definition content of a master node on a probability distribution of the slave node is further input as a definition element of the Bayesian network, and the Bayesian network is generated using the input information. That is, since the Bayesian network is generated based on the weight indicating the degree of influence of the definition content of the master node on the probability distribution of the slave node, it is possible to design the Bayesian network in which human experience is reflected without requiring mathematical knowledge.

According to the present invention, a CPT of a slave node is automatically generated based on the weight. Accordingly, it is possible to reflect the business knowledge, the business experience, and the like in the Bayesian network only with a parameter of the weight without directly setting the CPT. As a result, it is possible to design a Bayesian network in which human experience is appropriately reflected without requiring mathematical knowledge.

According to the present invention, the average value of the probability distribution is varied in accordance with the range of probability values which the slave node is able to take in accordance with the weight and the probability of the master node, and a bias of the probability distribution of the slave node is adjusted based on the varied average value. Accordingly, it is possible to reflect the business knowledge, the business experience, and the like in the Bayesian network only with a parameter of the weight without directly setting the CPT. As a result, it is possible to design a Bayesian network in which human experience is more appropriately reflected without requiring mathematical knowledge.

[Configuration of Information Processing Device]

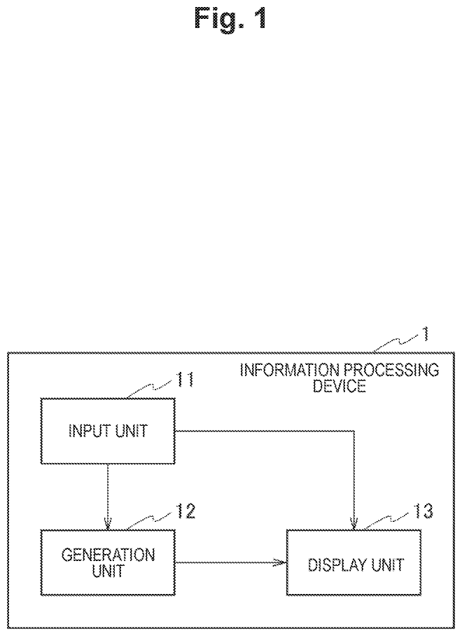

FIG. 1 is a diagram illustrating a functional block configuration of an information processing device 1 according to the present embodiment. The information processing device 1 is a device that designs a Bayesian network. The information processing device 1 includes an input unit 11, a generation unit 12, and a display unit 13.

The input unit 11 is a functional unit that inputs, a definition elements of a Bayesian network, information regarding a plurality of nodes indicating determination elements, an edge (arrow line) indicating a causal relation between a master node and a slave node in the plurality of nodes, a CPT for setting a probability (for example, an occurrence probability and a non-occurrence probability) of the slave node, and a weight indicating the degree of influence of definition content of the master node on a probability distribution of the slave node.

In the present embodiment, as a probability of a slave node, an occurrence probability and a non-occurrence probability of the slave node are used as an example. The slave node can take three or more values in addition to such two values. The master node can also take two or more values.

The generation unit 12 is a functional unit that forms a Bayesian network using the input information. The generation unit 12 is a functional unit that generates a CPT of the slave node based on the weight. For example, the generation unit 12 generates the CPT of the slave node by calculating the occurrence probability and the non-occurrence probability of the slave node based on the weight and setting the occurrence probability and the non-occurrence probability in the CPT. For example, the generation unit 12 generates a CPT of a slave node by calculating an average value of a probability distribution in accordance with a range of probability values which the slave node is able to take based on the weight, calculating the occurrence probability and the non-occurrence probability of the slave node based on the probability distribution of the slave node that has the average value, and setting the probability and the non-occurrence probability in the CPT. When the occurrence probability and the non-occurrence probability of the slave node are calculated, the generation unit 12 varies the average value of the probability distribution in accordance with the range of the probability value that the slave node can take in accordance with the weight and the index value or random variables (for example, the occurrence probability and the non-occurrence probability) of the master node, and adjusts a bias of the probability distribution of the slave node based on the varied average value.

The display unit 13 is a functional unit that displays a definition element of the Bayesian network, a design diagram of the Bayesian network, a CPT, and the like on a screen.

[Operation of Information Processing Device]

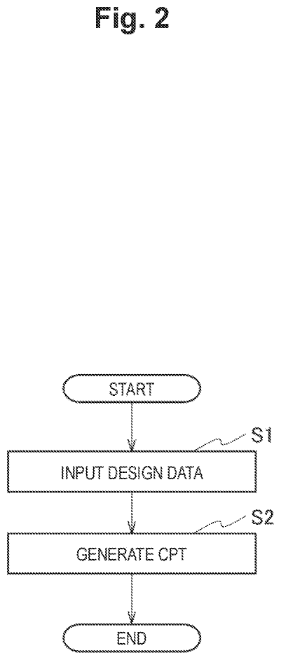

FIG. 2 is a diagram illustrating a processing flow of the information processing device 1 according to the present embodiment.

Step S1;

The display unit 13 first displays a GUI for setting a definition element of the Bayesian network on a screen. Next, the input unit 11 inputs a plurality of nodes indicating a determination element, an edge indicating a causal relation between a master node and a slave node in the plurality of nodes, and a weight indicating the degree of influence of the definition content of the master node on the probability distribution of the slave node, which are input to the GUI by the user.

For example, a node X₁ of Pollution, a node X₂ Smoker, and a node X₃ of Cancer are input. In addition, an edge E₁ that has the node X₁ as a connection source and has the node X₃ as a connection destination and an edge E₂ that has the node X₂ as a connection source and has the node X₃ as a connection destination are input. Furthermore, a weight w₁ for the edge E₁ and a weight w₂ for the edge E₂ are input.

The weights w₁ and w₂ increase weights that are desired to have a greater influence on the slave node X₃ between the master nodes X₁ and X₂. For example, since it is considered that Smoker has a higher probability of causing Cancer than Pollution (Smoker has a stronger influence on Cancer), 0.7 is input as the weight w₂ and 0.3 is input as the weight w₁. A sum of the weights w: and w₂ is 1.

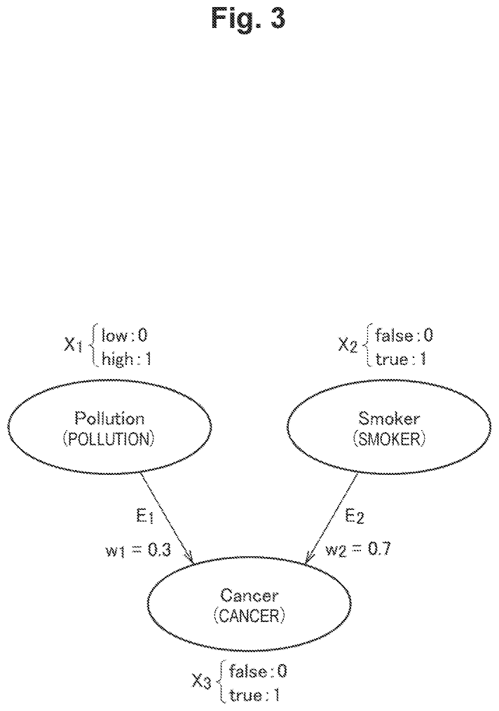

Accordingly, the Bayesian network illustrated in FIG. 3 is displayed on the screen. Characters and numbers illustrated on the right side of the master nodes X₁ and X₂ are index values of the master nodes. Instead of an index value of 0 or 1, random variables (an occurrence probability and a non-occurrence probability) of the master node may be used.

Step S2;

Next, the generation unit 12 calculates the probability distribution of the slave node X₃ using Expressions (1) and (2).

$$\begin{matrix}[ Math . 1 ] & \\ f ( z ) = \frac{1}{\sqrt{2 {πσ}^{2}} exp} ( - \frac{{( z - μ )}^{2}}{2 {σ}^{2}} ) & ( 1 )\end{matrix}$$

$$\begin{matrix}[ Math . 2 ] & \\ μ = \frac{1}{M} {\sum }_{j ∈ \{ 1 , 2 , 3 \}} {w}_{j} {x}_{j} & ( 2 )\end{matrix}$$

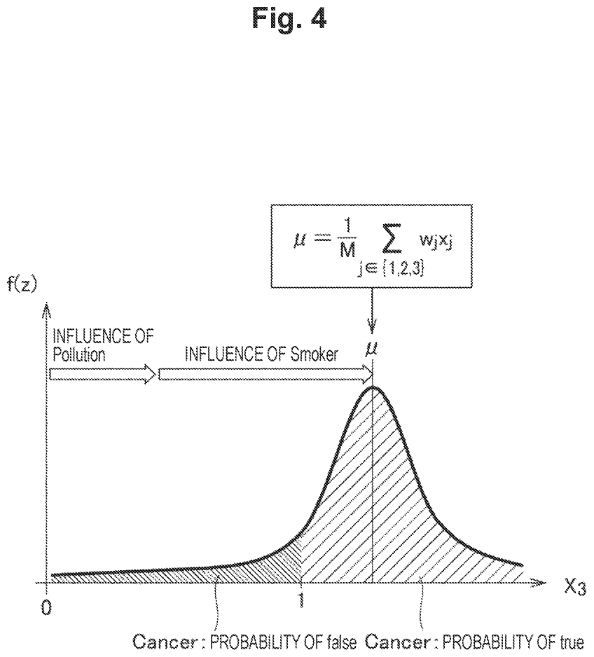

Expression (1) is an expression that defines a probability distribution f(z) of the slave node X₃. Expression (2) is an expression that defines an average value μ of the probability distribution f(z) using the weight w input in step S1. z is a random variable of the slave node X₃. σ is a variance value of the probability distribution f(z). xⱼ (where j ∈ 1, 2, 3) is an index value or a random variable of the node Xⱼ. M is a total value of cardinality numbers of the master nodes X₁ and X₂. The probability distribution f(z) of the slave node X₃ defined in Expressions (1) and (2) is a normal distribution, as illustrated in FIG. 4.

As in Expression (2), the average value μ of the probability distribution f(z) is obtained by a product of the weight w and the index value or the random variable of the node X. Therefore, the probability distribution f(z) of the slave node X₃ is biased such that the probability of the slave node is a higher value as the index value or the random variable of the node X is larger. The probability distribution f(z) of the slave node X₃ is biased such that the probability of the slave node is a higher value as the master node of the edge has a larger weight w.

As in Expression (2), a sum of a product of the weight w and the index value or the random variable of the node X is divided by M. Therefore, when the cardinality value of the slave node tends to increase as the cardinality value of the master node increases, the occurrence probability of an initial value with high accuracy is obtained.

By using Expressions (1) and (2), the generation unit 12 varies the average value μ of the probability distribution in accordance with the range of the probability value which the slave node X₃ is able to take in accordance with the weight w and the index value or the random variable of the master node X, and adjusts a bias f(z) of the probability distribution of the slave node X₃ based on the varied average value p.

Next, the generation unit 12 calculates a probability P of the slave node X₃ using Expression (3).

$$\begin{matrix}[ Math . 3 ] & \\ P ( {X}_{3} = {x}_{3} \vert {X}_{1} = {x}_{1} , {X}_{2} = {x}_{2} ) = \{ \begin{matrix}\begin{matrix}{\int }_{- ∞}^{0} f ( z ) dz if {x}_{3} = 0 \\ {\int }_{max ( {X}_{3} )}^{+ ∞} f ( z ) dz if {x}_{3} = max ( {X}_{3} )\end{matrix} \\ {\int }_{{X}_{3}}^{{X}_{3} + 1} f ( z ) dz if 0 < {x}_{3} < max ( {X}_{3} )\end{matrix} & ( 3 )\end{matrix}$$

For example, when the index value of the slave node X₃ is max (X₃), that is, 1, the generation unit 12 sets a value integrated in a range from max (X₃) to +∞ as the occurrence probability of the slave node X₃. The generation unit 12 calculates the occurrence probability and the non-occurrence probability of the slave node X₃ for all the combinations of the possible index values which the three nodes X: to X₃ are able to take.

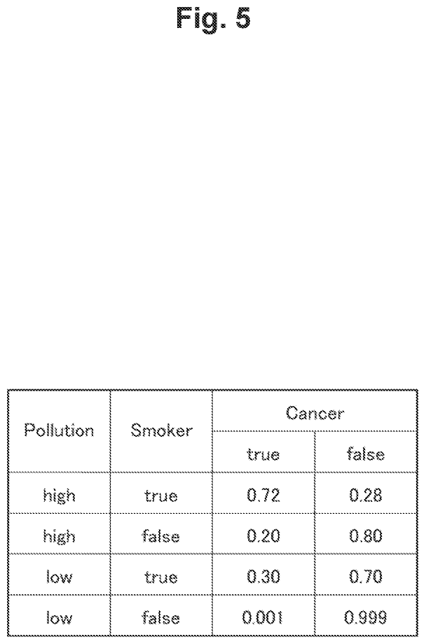

Finally, the generation unit 12 sets the occurrence probability and the non-occurrence probability of the slave node X₃ of all the combinations in the CPT (see FIG. 5). As a result, the generation unit 12 generates the CPT of the slave node X₃ and designs one Bayesian network together with the definition element input in step S1.

Expressions (1) to (3) are related to each other and can be said to be an expression group for generating the CPT of the slave node based on the weight and an expression group for calculating the average value of the probability distribution of the slave node based on the weight and generating the CPT of the slave node based on the probability distribution of the slave node that has the average value.

### Effects

According to the present embodiment, the information processing device 1 includes, the input unit 11 configured to input, as elements of a Bayesian network, information regarding a plurality of nodes, an edge indicating a causal relation between a master node and a slave node in the plurality of nodes, and a weight indicating the degree of influence of a definition content of the master node on a probability distribution of the slave node; and the generation unit 12 configured to generate a Bayesian network using the input information Therefore, it is possible to design the Bayesian network in which human experiences are reflected without requiring mathematical knowledge.

[Others]

The present invention is not limited to the foregoing embodiments. The present invention can be modified in various forms within the gist of the present invention.

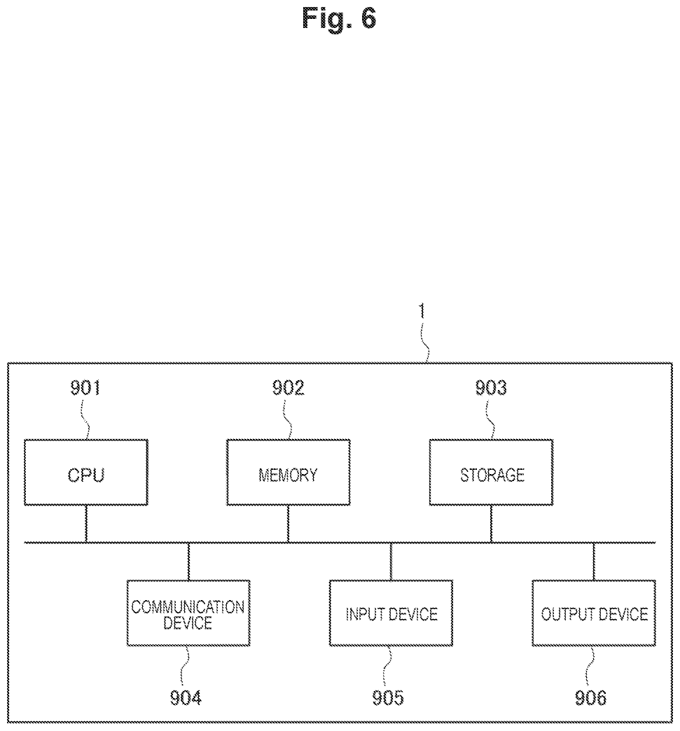

For example, as illustrated in FIG. 6, the information processing device 1 according to the above-described present embodiment can be implemented using a general-purpose computer system that includes a CPU 901, a memory 902, a storage 903, a communication device 904, an input device 905, and an output device 906. The memory 902 and the storage 903 are storage devices. In the computer system, each function of the information processing device 1 is implemented by the CPU 901 executing a predetermined program loaded on the memory 902.

The information processing device 1 may be mounted by one computer. The information processing device 1 may be mounted by a plurality of computers. The information processing device 1 may be a virtual machine that is mounted on a computer. The program for the information processing device 1 can be stored in a computer-readable recording medium such as an HDD, an SSD, a USB memory, a CD, or a DVD. The program for the information processing device 1 can also be distributed via a communication network.

### REFERENCE SIGNS LIST

1 Information processing device
11 Input unit
12 Generation unit
13 Display unit
901 CPU
902 Memory
903 Storage
904 Communication device
905 Input device
906 Output device

1. An information processing device configured to design a Bayesian network, the information processing device comprising:
an input unit, implemented using one or more processors, configured to input, as elements of a Bayesian network, information regarding a plurality of nodes, an edge indicating a causal relation between a master node and a slave node in the plurality of nodes, and a weight indicating the degree of influence of a definition content of the master node on a probability distribution of the slave node; and
a generation unit, implemented using the one or more processors, configured to generate a Bayesian network using the input information.

2. The information processing device according to claim 1,
wherein the generation unit is configured to generate a conditional probability table of slave nodes based on the weight.

3. The information processing device according to claim 2,
wherein the generation unit is configured to calculate an average value of a probability distribution in accordance with a range of probability values which the slave node is able to take based on the weight, and generate a conditional probability table of the slave node based on a probability distribution of the slave node that has the average value.

4. The information processing device according to claim 3, wherein the generation unit is configured to vary the average value of the probability distribution in accordance with the range of probability values which the slave node is able to take in accordance with the weight and the probability of the master node, and adjust a bias of the probability distribution of the slave node based on the varied average value.

5. An information processing method performed by an information processing device configured to design a Bayesian network, the method comprising:
inputting, as elements of a Bayesian network, information regarding a plurality of nodes, an edge indicating a causal relation between a master node and a slave node in the plurality of nodes, and a weight indicating the degree of influence of a definition content of the master node on a probability distribution of the slave node; and
generating a Bayesian network using the input information.

6. A non-transitory computer readable medium storing a program, wherein execution of the program causes a computer to function as an information processing device by performing operations comprising:
inputting, as elements of a Bayesian network, information regarding a plurality of nodes, an edge indicating a causal relation between a master node and a slave node in the plurality of nodes, and a weight indicating the degree of influence of a definition content of the master node on a probability distribution of the slave node; and
generating a Bayesian network using the input information.
